(19) United States
(12) Patent Application Publication
(10) Pub. No.: US 2020/0000139 A1
(43) Pub. Date: Jan. 2, 2020

(54) PROCESS OF COMPACTING A MICROPOROUS FAT POWDER AND COMPACTED FAT POWDER SO OBTAINED

(71) Applicant: Unilever BCS US, Inc., Englewood Cliffs, NJ (US)

(72) Inventors: René Joachim BUTER, SL Vlaardingen (NL); Albert KORRES, AT Vlaardingen (NL); Teunis de MAN, Maassluis (NL)

(73) Assignee: Unilever BCS US, Inc., Englewood Cliffs, NJ (US)

(21) Appl. No.: 16/023,222

(22) Filed: Jun. 29, 2018

(51) Int. Cl. A23P 30/20; A23D 9/05; A23D 7/00; A23D 7/04

(52) U.S. Cl. CPC A23P 30/20; A23D 7/04; A23D 7/001; A23D 9/05

(57) ABSTRACT

The present invention relates to a process of compacting a microporous fat powder, notably a microporous fat powder that can suitably be used as an oil structuring agent.

One aspect of the invention relates to a process for compacting a microporous fat powder, said process comprising:
feeding the fat powder into the feed zone of an extruder having a forwarding screw and a barrel within which said screw is centrally positioned;
rotating said forwarding screw to advance said fat powder feed through a compacting zone of the extruder where the barrel comprises a plurality of venting openings having a shorter dimension that exceeds the volume weighted average diameter of the fat powder feed and that is less than 10 mm; and
expelling the compacted fat powder from the extruder;
   wherein the temperature of the fat powder during passage through the extruder is maintained below 40° C. and wherein the compaction factor achieved exceeds 1.5

Another aspect of the invention relates to a compacted microporous fat powder having the following characteristics:
a freely settled density in the range of 90-600 g/l;
a particle size distribution with at least 90 vol. % of the particles having a diameter in the range of 20 to 600 μm;
a maximum G′ᵢ/G′_{d} ratio of more than 2.0, wherein G′ represents the elastic modulus at 10° C. of a dispersion of 2 wt. % of the compacted fat powder in glycerol, and wherein the maximum ratio is determined by recording G′ᵢ whilst increasing the frequency from 0.1 to 15 s⁻¹, by subsequently recording G′_{d} whilst decreasing said frequency from 15 to 0.1 s⁻¹, and by calculating the ratio G′ᵢ/G′_{d} at the frequency at which said ratio is highest.

### TECHNICAL FIELD OF THE INVENTION

The present invention relates to a process of compacting a microporous fat powder, notably a microporous fat powder that can suitably be used as an oil structuring agent. The process comprises feeding the fat powder into the feed zone of an extruder having a forwarding screw and a barrel in which said screw is positioned; rotating said forwarding screw to advance said fat powder feed through a compacting zone of the extruder; and expelling the compacted fat powder from the extruder.

The invention further provides a compacted microporous fat powder having oil structuring properties and a process for the preparation of an oil containing foodstuff comprising such a compacted fat powder.

### BACKGROUND OF THE INVENTION

Fat continuous food products are well known in the art and include, for example, shortenings comprising a fat phase and water-in-oil emulsions such as spreads, butter, kitchen margarines and bakery margarines.

The fat phase of these products usually comprises a mixture of liquid oil (i.e. fat that is liquid at ambient temperature) and fat which is solid at ambient temperatures. The solid fat, also called structuring fat or hardstock fat, serves to structure the fat phase and helps to stabilize the aqueous phase, if present, by forming a fat crystal network.

Shortenings and spreads are commonly produced by a process that encompasses the following steps:
mixing of liquid oil, structuring fat and if present aqueous phase at a temperature at which the structuring fat is fully molten;
cooling the mixture under high shear to induce crystallization of the structuring fat and to create an emulsion (if water is present);
allowing the formation of a fat crystal network to stabilize the resulting emulsion and to impart a degree of firmness;
modification of the crystal network to control firmness, plasticity and water droplet size of the final product.

These steps are usually conducted in a so called churn process or votator process. The churn process and the votator process are described in the Ullmans Encyclopedia, Fifth Edition, Volume A 16, pages 156-158. The energy consumption of these processes is substantial.

WO 2005/014158 describes a process for the preparation of an edible dispersion comprising oil and structuring agent and one or more of an aqueous phase and/or a solid phase, in which the dispersion is formed by mixing oil, solid structuring agent particles and the aqueous phase and/or the solid phase, wherein the solid structuring agent particles have a microporous structure of submicron size particles. The solid structuring agent particles are produced by preparing a homogeneous mixture of structuring agent and liquefied gas or supercritical gas at a pressure of 5-40 MPa and expanding the mixture through an orifice, under such conditions that a spray jet is formed in which the structuring agent is solidified and micronized.

The structuring agent particles described in WO 2005/014158 offer the advantage that they enable substantial energy savings to be realized in the production of fat-continuous food products such as spreads and shortenings.

The freely settled density of the structuring agent particles according to WO 2005/014158 typically lies in the range of 10-200 g/l. Shipping and storing materials with such a low density is relatively expensive. Hence, there is a need for a structuring agent that combines the advantages of the structuring agent particles of WO 2005/014158 with a substantially higher density.

WO 2006/087092 describes granules comprising:

a) solid micronized lipid powder particles that have a microporous structure; and
b) a liquid;
wherein the granule is an agglomeration of said lipid particles. These granules are produced by spraying a sticky liquid onto micronized fat powder to glue the particles of the fat powder together.

### SUMMARY OF THE INVENTION

The inventors have unexpectedly discovered that an oil structuring agent having a substantially higher density than a microporous fat powder according to WO 2005/014158 can be produced efficiently at high throughput without adversely affecting its oil structuring capacity by compacting the latter microporous fat powder in a special extruder under controlled conditions. More particularly, the inventors have found that this can be achieved by:
feeding the microporous fat powder into the feed zone of an extruder having a forwarding screw and a barrel within which said screw is centrally positioned;
rotating said forwarding screw to advance said fat powder feed through a compacting zone of the extruder where the barrel comprises a plurality of venting openings having a shorter dimension that exceeds the volume weighted average diameter of the fat powder feed and that is less than 10 mm; and
expelling the compacted fat powder from the extruder;
   wherein the temperature of the fat powder during passage through the extruder is maintained below 40° C. and wherein the compaction factor achieved exceeds 1.5

The use of extruders for compacting powders is known in the art. GB-A 2 208 378 describes a deaerator for particulate materials comprising a cylindrical body having a charge port at one end and a discharge port at the other end, and a screw conveyor rotatably mounted within the body and arranged to transport particulates from the charge port to the discharge port on rotation, the body having a portion intermediate its ends which is perforated and which includes a filter, the intermediate portion being surrounded by an outer cylinder to define an evacuation chamber therebetween, the evacuation chamber having an evacuation opening and a compressed-air opening, the screw conveyor being so arranged that the space afforded by the screw thread of the conveyor reduces at least in the downstream region beyond the end of the intermediate portion of the body. Particulate material which is still at a low bulk density is charged through the charge portion to the cylindrical body, the screw conveyor transfers the material towards the discharge port in the transfer chamber defined between the cylindrical body and screw conveyor, during which the material is subjected to suction through the evacuation pipe and the evacuation chamber formed between the perforated cylindrical section and the outer cylinder, so that the air in the material may be removed.

Example 1 of GB 2 208 378 describes deaeration of an unspecified particulate having a bulk density of 0.035 g/cm³ using a screw conveyor having a screw pitch which gradually decreased from 110 mm to 75 mm, and by applying vacuum to remove air through the perforated cylindrical section. Thus, an increase in bulk density of more than a factor 3 is achieved.

The oil-structuring properties of the microporous fat powder that is used as a starting material in the present process is believed be to associated with the micropores present in the fat particles, notably the high surface area provided by these micropores. It is unexpected that such a microporous fat powder can be compacted in an extruder without significant loss of oil-structuring capacity as one would expect the pressures exerted in the extruder to destroy micropores and to cause the formation of agglomerates. Surprisingly, however, the present process makes it possible to achieve compaction factors of 3.0 or more without substantial loss in oil-structuring capacity. Furthermore, the present process offers the advantage that the process can be operated at very high throughput without loss of compaction efficiency or oil-structuring capacity.

DE 32 20 916 describes a roller press for compacting pulverulent or fine-crystalline materials. The materials are delivered by a conveyor screw into the roller nip of the roller press. Immediately before the roller nip, the delivery channel of the delivery section is surrounded by a porous sleeve of sintered material, which sleeve forms the inner shell of a chamber which is under vacuum. The air released by the increasing compaction of the material being conveyed is extracted via the sleeve, so that even pulverulent or fine-crystalline material, which can otherwise hardly be processed, can be processed at a high degree of compaction. The roller press according to DE 32 20 916 is particularly suited for processing very small particulates (<10 μm).

The present process employs an extruder whose barrel comprises a plurality of venting openings in the part of the extruder where compaction occurs, A critical element of the process lies in the dimensions of the venting openings. These venting openings have a shorter dimension that exceeds the volume weighted average diameter of the fat powder. Despite the relatively large size of the venting openings, relatively little fat powder goes through these venting openings during compaction whilst air escapes very efficiently without the need of vacuum. Furthermore, it was found that when the fat powder that exits the compacting zone through the venting opening is (re)combined with the compacted fat powder that is expelled axially from the extruder, the overall compaction factor can still be sufficient.

The invention also provides a compacted microporous fat powder that has oil structuring capacity, said a compacted microporous fat powder having the following characteristics:
a fat content of at least 50 wt. %;
a solid fat content at 20° C. (N₂₀) of least 10 wt. %; a freely settled density in the range of 90-600 g/l;
a particle size distribution with at least 90 vol. % of the particles having a diameter in the range of 20 to 600 μm;
a maximum G′ᵢ/G′_{d} ratio of more than 2.0, wherein G′ represents the elastic modulus at 10° C. of a dispersion of 2 wt. % of the compacted fat powder in glycerol, and wherein the maximum ratio is determined by recording G′, whilst increasing the frequency from 0.1 to 15 s⁻¹, by subsequently recording G′_{d} whilst decreasing said frequency from 15 to 0.1 s⁻¹, and by calculating the ratio G′ᵢ/G′_{d} at the frequency at which said ratio is highest.

Furthermore, the invention is concerned with the use of such a compacted microporous fat powder in the production of food products.

### DETAILED DESCRIPTION OF THE INVENTION

Accordingly, one aspect of the invention relates to a process for compacting a microporous fat powder in an extruder, said microporous fat powder having the following characteristics:
a fat content of at least 50 wt. %;
a solid fat content at 20° C. (N₂₀) of least 10 wt. %;
a freely settled density in the range of 10 to 200 g/l, preferably in the range of 20 to 150 g/l;
a particle size distribution with at least 90 wt. % of the particles having a diameter in the range of 3 to 400 μm, preferably in the range of 5 to 300 μm;
   said process comprising:
feeding the fat powder into the feed zone of an extruder having a forwarding screw and a barrel within which said screw is centrally positioned;
rotating said forwarding screw to advance said fat powder feed through a compacting zone of the extruder where the barrel comprises a plurality of venting openings having a shorter dimension that exceeds the volume weighted average diameter of the fat powder feed and that is less than 10 mm; and
expelling the compacted fat powder from the extruder;
   wherein the temperature of the fat powder during passage through the extruder is maintained below 40° C. and wherein the compaction factor achieved exceeds 1.5.

The term “fat” as used herein encompasses triglycerides, diglycerides, monoglycerides, free fatty acids, phospholipids and combinations thereof. Fat may be liquid or solid at ambient temperature.

The term “microporous” as used herein in relation to powders refers to a particulate fatty material that is made up of particles that comprise a plurality of pores, holes, and/or channels. The solid fat content of a fat at a given temperature of x° C. (Nₓ) can be determined by NMR pulse technique using the procedure described in Fette, Seifen, Anstrichmittel 80, (1978), 180-186.

The “compaction factor” is defined herein as the ratio that is obtained when the freely settled density of the compacted powder obtained in the present process is divided by the freely settled density of the microporous fat powder that is used as the starting material in the same process. Thus, if the microporous fat powder that is used as a starting material has a freely settled density of 90 g/l and the compacted powder produced has a freely settled density of 240 g/l, the compaction factor equals 240/90=2.67.

Whenever reference is made herein to the melting point of a fat or a fat powder, said melting point is determined by ISO method 6321:2002 (Animal and vegetable fats and oils—Determination of melting point in open capillary tubes (slip point)).

The particle size distribution of compacted and non-compacted fat powders can suitably be determined with the help of a QICPIC™ image analysis sensor (ex Sympatec).

Besides fat the microporous fat powder may suitably contain minor amounts of other ingredients, such as flavouring, anti-oxidants, emulsifiers, vitamins, minerals and colouring. Typically, the fat powder contains at least 80 wt. %, more preferably at least 90 wt. % and most preferably at least 95 wt. % of fat.

Triglycerides and diglycerides together typically represent at least 80 wt. %, more preferably at least 90 wt. % and most preferably at least 95 wt. % of the fat. According to a particularly preferred embodiment, triglycerides constitute at least 80 wt. %, more preferably at least 85 wt. % and most preferably at least 90 wt. % of the fat.

The benefits of the present invention are most pronounced in case a fat powder is employed that has a solid fat content at 20° C. (N₂₀) of at least 20 wt. %, more preferably of at least 35 wt. % and most preferably of at least 50 wt. %.

According to a particularly preferred embodiment the fat powder has a solid fat contents N₁₀ from 50 to 100, N₂₀ from 26 to 95 and N₃₅ from 5 to 60.

The fat powder employed in the present process typically has a melting point in excess of 35° C. More preferably, the fat powder has a melting point in excess of 40° C., even more preferably in excess of 44° C. and most preferably in excess of 48° C.

Advantageously, the fat powder of the present invention is a free flowing powder. According to a particularly preferred embodiment, the freely settled density of the fat powder lies in the range of 30 to 120 g/l.

The microporous fat powder that is fed into the feed zone of the extruder typically has a particle size distribution with at least 90 wt. % of the particles having a diameter in the range of 8 to 200 μm,

In accordance with another preferred embodiment, the fat powder has a volume weighted average particle size in the range of 20 to 250 μm, more preferably in the range of 25 to 200 μm, and most preferably in the range of 30 to 150 μm.

In order to ensure that the oil-structuring properties of the fat powder are retained after compaction, it is important that not more than a minor fraction of the solid fat contained in the powder becomes molten during extrusion. Thus, in accordance with a preferred embodiment, the amount of solid fat that is molten during extrusion does not exceed 30%, preferably does not exceed 15% by weight of the fat powder.

Typically, during the compacting in the extruder the temperature of the microporous fat powder is maintained at a temperature that is at least 5° C., more preferably at least 10° C. and most preferably at least 15° C. below the melting point of the fat powder.

During the compacting in the extruder the temperature of the fat powder is advantageously maintained in the range of −5-25° C., more preferably in the range of 0-20° C. and most preferably in the range of 3-15° C.

The compaction factor achieved in the present process typically lies in the range of 1.5 to 10. Particularly good results are obtained with the present process if the compaction factor achieved lies in the range of 1.7 to 6, especially in the range of 1.9 to 3.0.

The compaction factor achieved in the process is largely determined by the extent to which the volume accommodated in the screw flights decreases in the (axial) direction of extrusion. A “screw flight” is the volume defined by adjacent screw threads completing one complete turn on the screw shaft. Compaction can be achieved in the compacting zone of the extruder by gradually decreasing the screw flight in the direction of extrusion. This may be achieved, for instance, by decreasing the pitch of the forwarding screw and/or by reducing the height of the thread of the forwarding screw in the same direction and/or by increasing the shaft diameter, all in the direction of extrusion.

In accordance with a preferred embodiment, within the compacting zone the screw flight decreases by at least a factor 1.5, more preferably by a factor 1.7 and most preferably by a factor 1.9 in the direction of extrusion. Typically, the screw flight decreases by not more than a factor 8 in the direction of extrusion. Even more preferably, the screw flight decreases by not more than a factor 6 in the direction of extrusion.

As explained herein before, the present process offers the advantage that it can be operated efficiently at high throughput. Advantageously, the present process is used to process at least 100 kg/hr, more preferably at least 300 kg/hr and most preferably at least 800 kg/hr of microporous fat powder.

In the present process effective compaction can be achieved when the forwarding screw is rotated at more than 5 rpm. Preferably, the forwarding screw is rotated at more than 15 rpm. Most preferably, the forwarding screw is rotated at more than 40 rpm. Typically, the forwarding screw is rotated at not more than 400 rpm.

As explained herein before, the dimensions of the venting openings, especially the shorter dimension of these openings, are a critical feature of the present process. If the venting openings are too small clogging will occur. If the venting openings are too large compaction efficiency will be lost.

The venting openings in the compacting zone of the extruder have a shorter dimension that exceeds the volume weighted average diameter of the fat powder feed. According to a particularly preferred embodiment, at least 60 wt. %, more preferably at least 70 wt. % and most preferably at least 75 wt. % of the particles contained in the fat powder feed have a diameter that is less than the shorter dimension of the venting openings.

In accordance with a particularly preferred embodiment, the shorter dimension of the venting openings exceeds 50 μm. Even more preferably, the shorter dimension exceeds 100 μm. Typically, the shorter dimension does not exceed 10 mm. More preferably, said shorter dimension does not exceed 5 mm, most preferably it does not exceed 3 mm.

The venting openings comprised in the barrel of the extruder typically have an aspect ratio 1:1 to 10,000:1. More preferably the aspect ratio is in the range of 1:1 to 5,000:1, even more preferably in the range of 1:1 to 1,000:1.

In order to ensure that air can escape at an adequate rate, the barrel of the extruder used in the present process typically comprises at least 20 venting openings in the compacting zone. Even more preferably, the barrel contains at least 100 venting openings and most preferably it contains at least 200 venting openings.

Together, the venting openings typically represent less than 60% of the surface area of the barrel in the compacting zone. More preferably, the venting openings represent less than 50%, most preferably less than 40% of the surface area of the barrel. The venting openings typically represent at least 3%, more preferably at least 5% and most preferably at least 10% of the surface area of the barrel in the compacting zone.

As explained herein before, despite the fact that the venting openings in the barrel are larger than most of the particles contained in the fat powder, not more than a minor fraction of the fat powder goes through the venting opening in the present process. Typically, less than 30 wt. %, even more preferably less than 20 wt. % and most preferably less than 15 wt. % of the fat powder feed that is advanced through the compacting zone exits the barrel through the venting openings.

As explained herein before, it was found that when the fat powder that exits the compacting zone through the venting opening is (re)combined it with the compacted fat powder that is expelled axially from the extruder, the overall compaction factor can still be sufficient. Thus, in accordance with a particularly preferred embodiment of the present process, the fat powder that leaves the compaction zone through the venting openings is combined with the compacted fat powder that is expelled from the extruder. Advantageously, said combining comprises mixing of the two fat powders.

The compacted fat powder obtained in the present process typically has a freely settled density of at least 90 g/l, more preferably of 120 to 600 g/l, even more preferably of 130 to 400 g/l and most preferably of 150 to 300 g/l.

In order to ensure that friction heat does not cause the fat powder to melt during extrusion, it is preferred that the barrel and/or the forwarding screw are actively cooled during the process.

Unlike the extrusion process described in GB 2 208 378 no suction needs to be applied to remove gas through the venting openings. Thus, advantageously the extruder employed in the present process does not comprise an evacuation chamber as described herein before in relation to GB-A 2 208 378.

Another aspect of the present invention relates to a compacted microporous fat powder having the following characteristics:
a fat content of at least 50 wt. %;
a solid fat content at 20° C. (N₂₀) of least 10 wt. %;
a freely settled density in the range of 90-600 g/l;
a particle size distribution with at least 90 vol. % of the particles having a diameter in the range of 20 to 600 μm;
a maximum G′ᵢ/G′_{d} ratio of more than 2.0, wherein G′ represents the elastic modulus at 10° C. of a dispersion of 2 wt. % of the compacted fat powder in glycerol, and wherein the maximum G′ᵢ/G′_{d} ratio is determined by recording G′, whilst increasing the frequency from 0.1 to 15 s⁻¹, by subsequently recording G′_{d} whilst decreasing said frequency from 15 to 0.1 s⁻¹, and by calculating the ratio G′ᵢ/G′_{d} at the frequency at which said ratio is highest.

The inventors have found that the compacted microporous fat powder of the present invention comprises agglomerates that are composed of fat particles that are loosely bound together. If these agglomerates are subjected to conditions of mild shear, the agglomerates break up (de-agglomeration). It is believed that the oil structuring capacity of the compacted microporous fat powder is largely determined by the non-agglomerated fat particles and that the compacted fat powder has retained this capacity because the fat particles are quickly released form the agglomerates when the compacted fat powder is dispersed in a liquid and the resulting slurry is subjected to shear (e.g. stirring).

The presence of agglomerates of fat particles that easily break up under conditions of mild shear is reflected by the requirement that the G′ᵢ/G′_{d} ratio exceeds 2.0.

The elastic modulus G′ is the mathematical description of an object or substance's tendency to be deformed elastically (i.e., non-permanently) when a force is applied to it. The elastic modulus of an object is defined as the slope of its stress-strain curve in the elastic deformation region: λ=stress/strain

wherein lambda (λ) is the elastic modulus; stress is the restoring force caused due to the deformation divided by the area to which the force is applied; and strain is the ratio of the change caused by the stress to the original state of the object.

G′ of the present compacted powder is determined by placing a sample of the powder-in-glycerol dispersion between two oscillating plates that have been equilibrated at 10° C. G′ is determined as a function of frequency, using an upward sweep of 0.1 to 15 Hz to monitor G′ᵢ, followed by a downward sweep from 15 to 0.1 Hz to monitor G′_{d}. The oscillating plates exert a certain amount of shear that increases with frequency. The agglomerated fat particles contained in the compacted powder of the present invention are gradually broken up as the oscillation frequency increases. As a result, the G′ values measured at lower frequencies during the downward sweep are substantially lower than those that were measured at these same frequencies during the upward sweep. In contrast, for non-compacted powders the G′ curves of the upward and downward sweep are essentially identical.

According to a particularly preferred embodiment, the G′ᵢ/G′_{d} ratio is at least 2.5, more preferably at least 3.0 and most preferably at least 4.0. Preferably, the compacted powder exhibits the latter ratio's at a frequency of 1 Hz, using the oscillation procedure described herein before.

The preferred fat contents and solid fat contents for the compacted microporous fat powder are identical to those already mentioned herein before in relation to the (non-compacted) fat powder.

Unlike the granulates described in WO 2006/087092 the compacted fat powder of the present invention is not made of agglomerates of fat particles that are held together by a sticky liquid, such as edible oil or a water-in-oil emulsion. The present compacted fat powder typically contains less than 30 wt. %, more preferably less than 20 wt. %, even more preferably less than 10 wt. % and most preferably less than 5 wt. % of free liquid oil.

In accordance with another preferred embodiment, the compacted fat powder contains less than 30 wt. %, more preferably less than 20 wt. %, even more preferably less than 10 wt. % and most preferably less than 5 wt. % of ingredients other than solid fat particles.

WO 2010/069746 and WO 2010/069750 describe microporous fat powders that may be used as oil-structuring agents. Unlike the fat powders described in these international patent applications, the compacted fat powder of the present invention typically has a full width at half maximum of the first order long spacing X-diffraction peak that is less than 0.00056×free flowing density+0.213.

The compacted microporous fat powder of the present invention is preferably obtainable, or even more preferably obtained by a compacting process as defined herein before.

Another aspect of the invention relates to the use of the compacted microporous fat powder as defined herein before as an oil-structuring agent, especially an oil-structuring agent for food products that contain at least 5 wt. % of liquid oil. Most preferably, the compacted fat powder is used as an oil-structuring agent in fat-continuous food products.

Yet another aspect of the present invention relates to a process of preparing a food product, said process comprising mixing the compacted microporous fat powder as defined herein before with liquid oil.

Typically, the compacted microporous fat powder is combined with the liquid oil in a weight ratio that lies in the range of 1:100 to 40:100, more preferably within the range of 3:100 to 25:100 and most preferably in the range 6:100 to 18:100.

The present process preferably comprises packaging of the final food product. According to a particularly preferred embodiment, the temperature of the mixture of compacted microporous fat powder and liquid oil is kept below the melting point of the fat powder until the product is packaged.

The food product obtained in the present process typically comprises at least 18 wt. % of a continuous fat phase.

Examples of food product that may suitably be produced by the present process include spreads, kitchen margarines, bakery margarines and shortenings.

The invention is further illustrated by means of the following non-limiting examples.

### EXAMPLES

Determination of the G′ᵢ/G′_{d} Ratio

A dispersion of fat powder in glycerol is prepared by adding 1 gram of fat powder to 49 grams of glycerol and by gently mixing the two components with a spatula (all ingredients being previously equilibrated at 5° C.). Next, about 3 grams of the slurry so obtained is placed on the bottom plate of a Peltier-controlled Rheometer (AR 2000, TA Instruments) which is thermostated at 10° C. The upper plate used in the Rheometer has a sand-blasted surface and a diameter of 40 mm.

The gap size between the two oscillating plates is to be chosen carefully when determining the maximum G′ᵢ/G′_{d} ratio. The G′ measurements described herein before should be performed with gap sizes of 200, 300 and 500 μm, and the gap size yielding the highest G′ᵢ/G′_{d} ratio should be used for the final result.

The maximum G′ᵢ/G′_{d} ratio is determined within the frequency range of 0.3 to 10 Hz.

### Comparative Example A

A microporous fat powder was produced from an interesterified fat using the Super Critical Melt Micronisation methodology described in WO 2005/014158. The interesterified fat was a randomly interesterified blend of multifractionated palm oil stearin having an IV of 14 (65 wt. %) and palm kernel oil (35 wt. %). The microporous fat powder so obtained had the properties described in Table 1.

TABLE 1

| Freely settled density | 60-80 g/l |
|---|---|
| Volume weighted average diameter | appr. 70 μm |
| Melting point | 48° C. |
| N₂₀ | 82.5% |

Compaction experiments were carried out in a cooled room at 5° C. The equipment was left long enough in this room to cool down to 5° C. The in-feed powder was stored at 5° C. and had a temperature of ca. 5° C.

Extrusion compaction was carried out in an AZODOS extruder comprising an extrusion screw with an external diameter of 55 mm (AZO Inc.). This particular extruder is a dosing system with a constant pitch and a pneumatically operated flat-shaped shut-off valve that can be used to give counter pressure for compaction.

A first trial resulted in compaction factors ranging from 3.2-4.8 at a throughput up to ca. 6.1 kg/hr. The counter pressure needed to be low, ca. 0.5 bar, in order to prevent shut-off. The in-feed section needed manual mixing in order to prevent bridging and pit-holes.

### Comparative Example B

Comparative Example A was repeated except that this time a screw with varying pitch was used. The pitch at the in-feed section of the screw was increased from ca. 30 mm to 60 mm. At the compaction side the pitch decreased from 60 mm to appr. 20 mm.

This resulted in a relatively constant compaction factor of 2.2-2.3 at throughputs from 4.6 to 8.1 kg/hr. The throughput increases with the rotational speed of the screw. At screw speeds higher than ca. 50 rpm, sufficient compaction was lost and/or the throughput did not increase significantly anymore.

### Example 1

Comparative Example B was repeated with the exception that the barrel of the extruder was replaced with a barrel containing a perforated stainless steel tube section having the properties described in Table 2.

TABLE 2

| | |
|---|---|
| Shape of the perforations | Circular |
| Shortest dimension of perforations | 1.5 mm |
| Wall thickness of the perforated section | 1.5 mm |
| Percentage surface perforated | 31% |
| Length of perforated section | 285 mm |

The manual mixing in the in-feed section was replaced by an automated in-feed mixer. The pitch at the in-feed section of the screw was increased from ca. 30 mm to 60 mm. At the compaction side the pitch decreased from ca. 60 mm to ca. 12 mm.

A constant compaction factor of 2.4 2.5 could be achieved at throughputs of up to 21.2 kg/hr (112 rpm). Temperature of the fat powder was found to increase around 3-4° C. in the compaction zone of the extruder.

The amount of fat powder that exited the extruder through the perforations in the extruder barrel was less than 15% by weight of the feed. This powder was mixed with the compacted fat powder that was expelled axially by the extruder. The compaction factors mentioned are measured from the combined out-feed.

### Example 2

Example 1 was repeated, except that this time the feed consisted of a freshly produced fat powder instead of a fat powder that had been stored at 5° C.

Compaction extrusion was started within 3 minutes after the powder had been produced. The powder at the in-feed section for compaction had a temperature of approximately 7° C.

The compaction factor and throughputs realized were very similar to those described in Example 1.

### Example 3

Example 2 was repeated, except that the extruder was replaced with a similar extruder that can be operated at higher throughputs as the external screw diameter was 90 mm (instead of 55 mm). The pitch of the screw of this extruder decreased from 100 mm to ca. 25 mm in the compaction zone. The length of the perforated section was 300 mm.

Compaction extrusion was started approximately 15 minutes after the last powder had been produced. The powder at the in-feed section for compaction had a temperature of approximately 10° C.

A constant compaction factor of about 2.2 could be realized at throughputs of up to 190 kg/hr (157 rpm). Temperature of the fat powder was found to increase around 4° C. in the compaction zone of the extruder.

### Example 4

The compacted powders described in Example 1 and 3, were used to produce a spread, using the recipe (Composition B) and process described in the Examples of WO 2010/069746. A reference spread was produced using the non-compacted powder instead of the compacted powder.

It was found that compaction had a negligible effect on the spread quality. The water droplets in the spread produced with the compacted powder were in some cases slightly larger than those in the reference spread. However, this difference could be negated very easily by increasing the speed of the C-unit (pin stirrer).

### Example 5

The compacted powder described in Example 3 and the fat powder that was used as a starting material for the production of that compacted powder were both subjected to a rheological test as described herein before (using a gap space of 300 μm) to determine the maximum G′ᵢ/G′_{d} ratio.

The results so obtained are summarized in Table 3.

TABLE 3

| | G′ | | | | | |
|---|---|---|---|---|---|---|
| | | | Non- | | G′ᵢ /G′_{d} ratio | |
| Frequency | Compacted | | compacted | | | Non- |
| (in Hz) | Up | Down | Up | Down | Compacted | compacted |
| 0.29 | 67.9 | 10.4 | 24.0 | 24.4 | 6.5 | 1.0 |
| 0.48 | 78.0 | 9.8 | 20.9 | 15.1 | 7.9 | 1.4 |
| 0.85 | 82.4 | 10.9 | 18.2 | 16.1 | 7.6 | 1.1 |
| 1.23 | 87.1 | 12.4 | 17.0 | 17.2 | 7.0 | 1.0 |
| 1.99 | 82.8 | 14.6 | 16.7 | 19.6 | 5.7 | 0.9 |
| 3.12 | 75.2 | 17.7 | 18.3 | 22.1 | 4.3 | 0.8 |
| 5.00 | 51.9 | 21.1 | 21.7 | 25.9 | 2.5 | 0.8 |
| 8.02 | 39.2 | 26.7 | 27.1 | 30.9 | 1.5 | 0.9 |
| 12.9 | 44.4 | 36.7 | 35.0 | 35.7 | 1.2 | 1.0 |

This data shows that the maximum G′ᵢ/G′_{d} ratio for the compacted powder was 7.9, whereas the maximum G′ᵢ/G′_{d} ratio for the non-compacted powder was only 1.4.

1.-9. (canceled)

10. Process according to claim 14, wherein G′ᵢ/G′_{d} ratio is at least 2.5, more preferably at least 3.0.

11. Process according to claim 14, wherein the compacted fat powder has a full width at half maximum of the first order long spacing X-diffraction peak that is less than 0.00056×free flowing density+0.213.

12-13. (canceled)

14. A process of preparing a food product, said process comprising mixing a compacted microporous fat powder having the following characteristics with liquid oil;
a fat content of at least 50 wt. %;
a solid fat content at 20° C. (N₂₀) of least 10 wt. %;
a freely settled density in the range of 90-600 g/l;
a particle size distribution with at least 90 vol. % of the particles having a diameter in the range of 20 to 600 μm;
maximum G′ᵢ/G′_{d} ratio of more than 2.0, wherein G′ represents the elastic modulus at 10° C. of a dispersion of 2 wt. % of the compacted fat powder in glycerol, and wherein the maximum G′ᵢ/G′_{d} ratio is determined by recording G′ᵢ whilst increasing the frequency from 0.1 to 15 s⁻¹, by subsequently recording G′_{d} whilst decreasing said frequency from 15 to 0.1 s⁻¹, and by calculating the ratio G′ᵢ/G′_{d} at the frequency at which said ratio is highest.

15. Process according to claim 14, wherein the food product is selected from the group of spreads, kitchen margarines, bakery margarines, shortenings.
